(19) United States
(12) Patent Application Publication
(10) Pub. No.: US 2025/0103375 A1
(43) Pub. Date: Mar. 27, 2025

(54) VIRTUAL LOCAL GATEWAY FOR LEGACY PERIPHERAL DEVICES

(71) Applicant: AMADEUS S.A.S., Biot (FR)

(72) Inventors: Edmond ABBOUD, Antibes (FR); Beranger CHANOIR, Peymeinade (FR); Sylvain FUALDES, Biot (FR)

(21) Appl. No.: 18/474,754

(22) Filed: Sep. 26, 2023

(51) Int. Cl. G06F 9/455

(52) U.S. Cl. CPC G06F 9/45558; G06F 2009/45562; G06F 2009/45579; G06F 2009/45587; G06F 2009/45595

(57) ABSTRACT

A method includes: obtaining, at a processor of a computing device, a virtual gateway application package including a setup component and a firmware component containing a server identifier; storing the virtual gateway application package in a memory of the computing device; via execution of the setup component: deploying the firmware component to the memory; generating a unique gateway identifier; and storing the unique gateway identifier in the memory; via execution of the firmware component: retrieving the unique gateway identifier and the server identifier; generating a configuration request, addressed to the server identifier and including the unique gateway identifier; receiving configuration data defining connection parameters for at least one peripheral device connected to the computing device; and establishing a connection with the at least one peripheral device according to the connection parameters.

### FIELD

The specification relates generally to interconnecting peripheral devices with server-based services, and specifically to a virtual local gateway for legacy peripheral devices.

### BACKGROUND

Various facilities, such as hotels, contain peripheral devices such as keycard encoders, telephone systems, point of sale (PoS) devices, and the like. An on-premise computing device, for example executing a property management system (PMS) application, has previously been used to connect to such peripheral devices, enabling integrated management of various aspects of the facility's operation, including those involving the peripheral devices.

Shifting PMS applications, or other enterprise applications applicable to other facilities that also contain peripheral devices, to a remote host (e.g., generally referred to as cloud applications) may relieve the facility itself of managing various aspects of the configuration and management of the enterprise application. However, some peripheral devices may not be capable of communication over Internet Protocol (IP) networks. Other peripheral devices, while able to communicate over IP networks, may nevertheless be prevented from communicating directly with an external server, e.g., due to on-site firewall devices, or the like. Managing and controlling such peripheral devices from a cloud-implemented enterprise application can therefore be technically challenging.

### SUMMARY

Examples disclosed herein provide a method including: obtaining, at a processor of a computing device, a virtual gateway application package including a setup component and a firmware component containing a server identifier; storing the virtual gateway application package in a memory of the computing device; via execution of the setup component: deploying the firmware component to the memory; generating a unique gateway identifier; and storing the unique gateway identifier in the memory; via execution of the firmware component: retrieving the unique gateway identifier and the server identifier; generating a configuration request, addressed to the server identifier and including the unique gateway identifier; receiving configuration data defining connection parameters for at least one peripheral device connected to the computing device; and establishing a connection with the at least one peripheral device according to the connection parameters.

Additional examples disclosed herein provide a computing device including: a memory; a communications interface; and a processor configured to: obtain a virtual gateway application package including a setup component and a firmware component containing a server identifier; via execution of the setup component: deploy the firmware component to the memory; generate a unique gateway identifier; and store the unique gateway identifier in the memory; via execution of the firmware component: retrieve the unique gateway identifier and the server identifier; generate a configuration request, addressed to the server identifier and including the unique gateway identifier; receive configuration data defining connection parameters for at least one peripheral device connected to the computing device; and establish a connection with the at least one peripheral device according to the connection parameters.

Further examples disclosed herein provide a non-transitory computer-readable medium storing a plurality of computer-readable instructions executable by a processor of a computing device to: obtain a virtual gateway application package including a setup component and a firmware component containing a server identifier; via execution of the setup component: deploy the firmware component to a memory; generate a unique gateway identifier; and store the unique gateway identifier in the memory; via execution of the firmware component: retrieve the unique gateway identifier and the server identifier; generate a configuration request, addressed to the server identifier and including the unique gateway identifier; receive configuration data defining connection parameters for at least one peripheral device connected to the computing device; and establish a connection with the at least one peripheral device according to the connection parameters.

### BRIEF DESCRIPTIONS OF THE DRAWINGS

Embodiments are described with reference to the following figures.

FIG. 1 is a diagram of a system implementing a cloud-based enterprise application.

FIG. 2 is a flowchart of a method of deploying and operating a virtual local gateway for legacy peripheral devices.

FIG. 3 is a diagram illustrating an example performance of blocks 205 and 210 of the method of FIG. 2.

FIG. 4 is a diagram illustrating an example performance of blocks 220 and 235 of the method of FIG. 2.

FIG. 5 is a diagram illustrating an example performance of blocks 240 and 245 of the method of FIG. 2.

### DETAILED DESCRIPTION

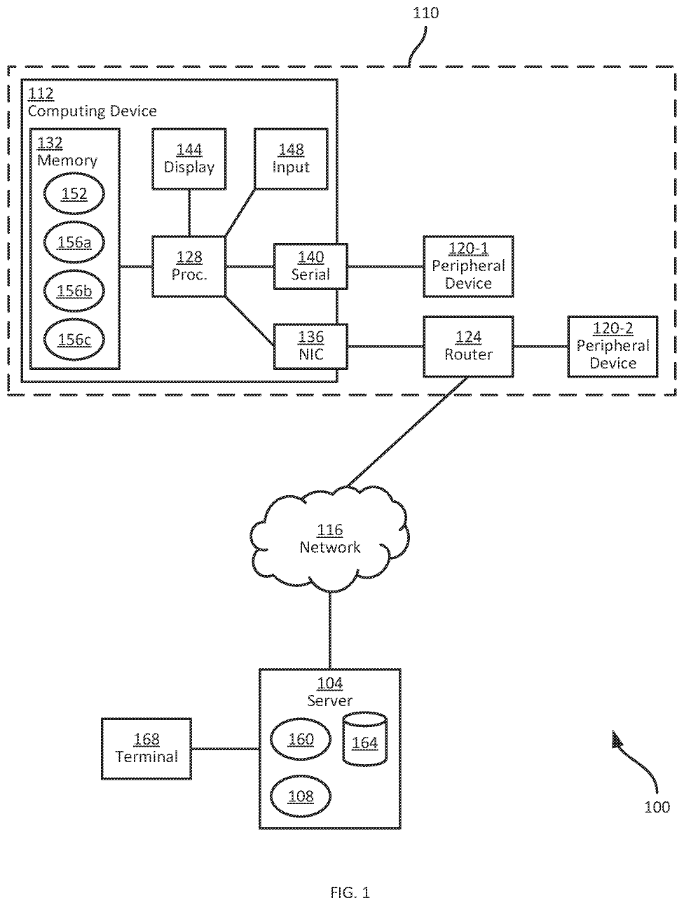

FIG. 1 illustrates a system 100 implementing a cloud-based enterprise application, such as a PMS operated by a hotel. As will be apparent to those skilled in the art, in the context of hotel operations, a PMS can include various components to track room reservations, check-in and check-out events, cleaning and other maintenance, staff scheduling, and the like. The system 100 can also implement a cloud-based (e.g., software-as-a-service or SaaS) PMS for facilities other than hotels, such as manufacturing facilities, warehousing facilities, or the like.

The system 100 can include, for example, a server 104 (which can be implemented in a distributed format, or as a discrete computing device) executing an enterprise application 108. The server 104 is generally remote from hotel premises 110 (or another suitable facility), and connected to an on-premises computing device 112 via one or more suitable networks, such as a wide-area IP network 116 (e.g., including the Internet). The computing device 112 can act as a client terminal to access the application 108, e.g., via a web browser, proprietary client application, or the like. The computing device 112, in other words, permits operators on-site at the hotel premises 110 to access data stored at the server 104. In some examples, a plurality of on-premises computing devices can be configured to access the application 108. In further examples, the computing device 112 may not be configured to access the application 108. Instead, the computing device 112 can implement virtual gateway functionality as described herein, while a different computing device on premises 110 can access the application 108.

The system 100 also includes certain elements on premises 110 that are difficult or impossible to relocate to the cloud. Examples of such elements include peripheral devices 120. Example peripheral devices 120-1 and 120-2 are shown in FIG. 1, and can include devices or collections of devices such as keycard encoders, telephone systems (e.g., a private branch exchange (PBX)), point-of-sale (PoS) devices, and the like. The peripheral devices 120, which can also be referred to as legacy devices, interact with physical components on premises 110, such as keycards, room telephones, and the like, and therefore generally remain on premises 110 even in systems where the controlling enterprise application 108 has been implemented in the cloud. Certain peripheral devices 120, however, may not be capable of IP-based communication, and therefore cannot communicate directly with the server 104. For example, the peripheral device 120-1 (e.g., a keycard encoder) may communicate via an RS232 port or the like. Other peripheral devices 120 may be capable of IP-based communication, but may be prevented from communicating outside the premises 110 by a firewall, e.g., implemented by a router 124.

In some previous systems, management of the peripheral devices 120 and interconnection of the peripheral devices 120 with the server 104 involves executing a local PMS application at the computing device 112. Such a local application may not implement the complete set of functions provided by the enterprise application 108, but may instead implement protocol translation to communicate with the peripheral devices 120 and, in some cases, may implement certain business logic to process data exchanged with the peripheral devices 120. Deploying such a local application, however, may involve on-site configuration and maintenance, which can counteract the benefits (e.g., scalability, out-sourced maintenance, and the like) of implementing the enterprise application 108 in the cloud.

Other systems, such as those described in U.S. Pat. No. 11,503,138, implement a local gateway appliance such as a mini-desktop computer with communications hardware to connect to the peripheral devices 120 (e.g., serial ports and the like). Such an appliance can execute software to encapsulate any data received from the peripheral devices, and transmit the encapsulated data to the server 104 for processing (e.g., for protocol translation, application of business logic, and the like). The server 104 can further provide commands for the peripheral devices 120 to the local appliance in a similarly encapsulated form. The appliance can in turn transmit such commands to the peripheral devices 120.

The local appliance, in such systems, need not be configured or maintained to apply business logic to data exchanged with the peripheral devices, and need instead only establish connections with the peripheral devices 120 to act as a relay between the peripheral devices 120 and the server 104. The appliance can receive configuration data for connecting to the peripheral devices 120 from the server 104.

The deployment of a local appliance, however, also suffers from certain weaknesses. For example, a hardware failure at the local appliance may be time-consuming to address, due to the proprietary nature of the appliance (in contrast to an arbitrary consumer-grade computing device). Replacement parts and/or maintenance expertise may, in other words, be difficult to source.

The system 100, to mitigate at least some of the above disadvantages of prior systems, implements a virtual local gateway for managing the peripheral devices 120. The virtual local gateway is, in contrast with the local hardware appliance mentioned above, a software application package deployed on any of a wide variety of computing devices, including consumer-grade devices generally already available on premises 110. Further, unlike systems implementing local PMS applications, the virtual local gateway acts simply as a relay between the server 104 and the peripheral devices 120, permitting business logic and other processing to remain at the server 104.

Deploying the virtual gateway application on an arbitrary computing device, rather than a dedicated appliance, involves certain technical challenges, however. A dedicated appliance as described in U.S. Pat. No. 11,503,138 can be provisioned (e.g., at a manufacturing stage, before being shipped to the premises 110) with a unique identifier known in advance to the operator of the server 104. Advance provisioning of such a unique identifier is generally not possible for the virtual gateway, since the virtual gateway application package can be installed on any of a wide variety of computing devices, none of which may be known to the server 104 in advance.

The server 104, in other words, exerts little or no direct control over which devices act as virtual gateways. Further, while gateway software can be installed on a dedicated appliance prior to shipping to the premises 110, the virtual gateway software is typically installed on premises 110, e.g., by staff at the hotel with varying levels of technical expertise. As discussed below, the computing device 112, via execution of the virtual gateway application package, as well as the server 104, implement various functionality to alleviate the above technical challenges.

Certain internal components of the computing device 112 are shown in FIG. 1. In the illustrated example, the computing device 112 includes at least one processor 128, such as a central processing unit (CPU), graphics processing unit (GPU), or the like. The processor 128 is interconnected with a memory 132, implemented as a suitable non-transitory computer-readable medium, such as a combination of volatile and non-volatile memory components (e.g., any one or more of Random Access Memory (RAM), read only memory (ROM), Electrically Erasable Programmable Read Only Memory (EEPROM), flash memory, magnetic computer storage, and the like). The processor 128 and the memory 132 are generally comprised of one or more integrated circuits (ICs).

The processor 128 is also interconnected with a communications interface 136, which enables the computing device 112 to communicate with other computing devices such as the server 104 and the peripheral device 120-2, e.g., via the router 124 and/or the network 116. The communications interface 136, in this example, includes a network interface controller (NIC) configured to enable IP-based communications. As will be apparent, the interface 136 can include one or more Ethernet ports, wireless radio assemblies, or the like.

The computing device 112 can also include a local communications interface 140, such as a serial controller, e.g., including one or more RS-232 ports or other suitable serial data transmission ports. The interface 140 is configured for direct connection to one or more peripheral devices 120, such as the peripheral device 120-1 in this example.

The computing device 112 can also include a display 144 and/or other suitable output device (e.g., speakers or the like), and one or more input devices 148, such as a keyboard, a mouse, or the like. The components of the computing device 112 are generally deployed in an enclosure located on premises 110, although certain devices, such as the display 144 and the input 148, can be peripherals in distinct housings from the processor 128, memory 132, and interfaces 136 and 140.

The memory 132 stores a plurality of computer-readable programming instructions, executable by the processor 128. The instructions stored in the memory 132 can be structured as a plurality of applications, each implementing a certain set of functions. For example, the memory 132 can store a web browser application 152, and/or any of a wide variety of other applications, given that the computing device 112 is generally deployed on premises 110 prior to deployment of the virtual gateway described herein, and may be used for various other purposes.

In addition to the web browser 152 and/or other applications, the memory 132 stores a virtual gateway application package. As discussed below, the virtual gateway application package can include certain components, which may be implemented as discrete applications. The package includes, for example, a setup component 156a executable by the processor 128 to deploy the package to the computing device 112. The package also includes a firmware component 156b executable to relay data between the peripheral devices 120 and the server 104. The package can also, in some examples, include a monitoring or control component 156c, executable alongside the firmware component 156b to provide status information and the like associated with the firmware component 156b.

The server 104, in addition to the enterprise application 108, can also execute an enrollment application 160, which may be responsible for registering and configuring virtual local gateways. The server 104 can also maintain a repository 164 of configuration data and registration records, e.g., tracking which virtual gateways have been authorized and configured to communicate with the enterprise application 108. The contents of the repository 164 may be viewed and/or edited, e.g., by an operator of the server 104, via a terminal 168.

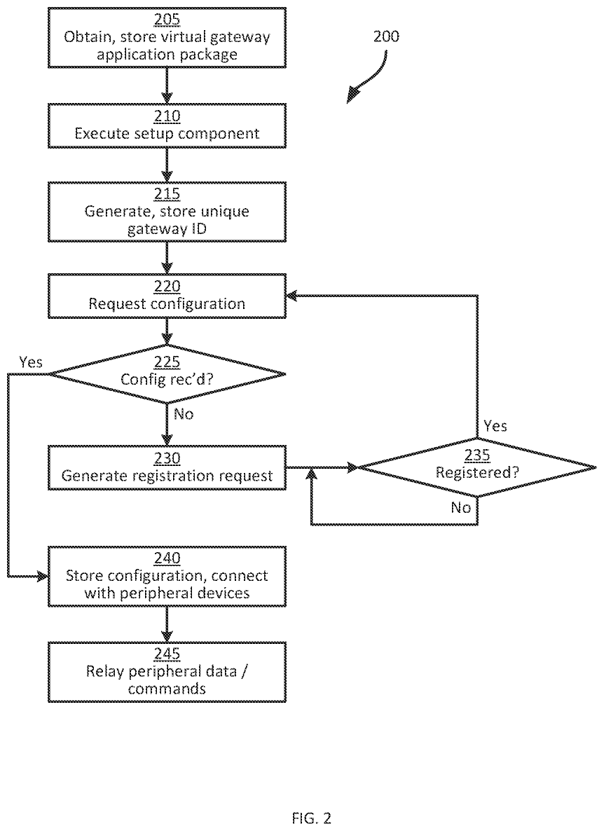

Turning to FIG. 2, a method 200 of deploying and operating a virtual local gateway for legacy peripheral devices is illustrated. The method 200 is described below in conjunction with its example performance by the computing device 112.

At block 205, the computing device 112 is configured to obtain the virtual gateway application package and store the package in the memory 132. For example, the computing device 112 can obtain the package via local storage such as a USB key or the like. In other examples, the computing device 112 can retrieve (e.g., via the web browser 152) the package from a website hosted by the server 104 or another computing device associated with the server 104 and connected with the network 116.

At block 210, the computing device 112 is configured to execute the setup application 156a to deploy the firmware application 156b and, if present, the control application 156c to the memory 132. The setup application 156a can be implemented, for example, as a self-extracting archive containing the firmware application 156a and control application 156c, and executable to extract the firmware application 156a and control application 156c to the memory 132.

At block 215, the computing device 112 is configured, via execution of the setup application 152a, to generate and store a unique gateway identifier. The generation of a unique gateway identifier can be performed substantially simultaneously with the execution of the setup application 156a and installation of the firmware application 156b and control application 156c. The unique gateway identifier can be employed subsequently in the method 200 to identify the computing device 112 to the server 104, given that the arbitrary nature of the computing device 112 itself may preclude the computing device 112 from being previously identified to the server 104.

The computing device 112 can generate the unique gateway identifier at block 215 based at least in part on certain hardware identifiers of components of the computing device 112. For example, the unique gateway identifier can be generated from a serial number of the interface 136 (e.g., retrieved from local memory on the interface 136), and/or a media access control (MAC) address of the interface 136. The unique gateway identifier can further include a universally unique identifier (UUID) value retrieved from a read-only memory of the computing device 112 (e.g., associated with a BIOS of the computing device 112 or the like). In other examples, the unique gateway identifier can include the MachineGuid value, e.g., retrieved from an operating system registry of the computing device. The MachineGuid value is generally created at the time the operating system is installed on the computing device 112. Thus, an example unique gateway identifier can include a serial number of the interface 136, concatenated with the MachineGuid value.

Having generated the unique gateway identifier, the computing device 112 is configured to store the unique gateway identifier in the memory 132, for example in a repository, a portion of the above-mentioned operating system registry, or the like.

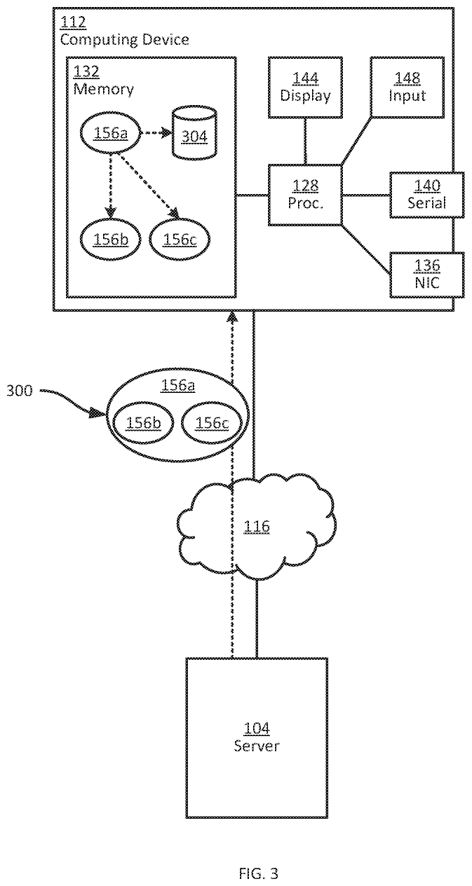

Turning briefly to FIG. 3, the computing device 112 is shown retrieving an application package 300, e.g., containing the applications 156b and 156c encapsulated within the setup application 156a in the form of a self-extracting archive. Upon receipt and storage of the package 300 in the memory 132, the computing device 112 can execute the application 156a to deploy the applications 156b and 156c to the memory 132 for execution by the processor 128. The application 156a can also generate the unique gateway identifier, as set out above, and store the unique gateway identifier in a repository 304 in the memory 132.

Returning to FIG. 2, at block 220, the computing device 112 is configured to execute the firmware application 156b, e.g., in response to installation of the application 156b. Via execution of the firmware application 156b, the computing device 112 is configured to request configuration data from the server 104. The performance of block 220 is also performed each time the firmware application 156b is launched after installation. That is, block 220 can be performed both after installation is complete at block 215, and any time thereafter that the firmware application 156b begins execution, e.g., when the computing device 112 is powered on, or in response to a user-originated command to begin executing the firmware application 156b.

The computing device 112, to perform block 220, generates a configuration request addressed to the server 104, and including the unique gateway identifier from block 215. The firmware application 156b can, for example, be configured to retrieve the unique gateway identifier from the repository 304, and to address the configuration request using a server identifier stored in the firmware application 156b itself. The server identifier can include a uniform resource locator (URL), an IP address, or the like. The configuration request can include an application programming interface (API) call or the like that the server 104 is configured to process via execution of the enrollment application 160.

The configuration request is a request for configuration data from the server 104 that enables the computing device 112 to establish connections with the peripheral devices 120, and relay data between the peripheral devices 120 and the server 104. When the firmware application 156b performs block 220 for the first time, e.g., in response to installation of the package 300 at the computing device 112, the repository 164 at the server 104 generally does not contain configuration data associated with the unique gateway identifier from block 215. The server 104 may therefore return, in response to the configuration request, a message indicating that no configuration data is available for the computing device 112, e.g., because the computing device 112 is not registered with the server 104.

At block 225, the device 112 is configured to determine whether configuration data has been received in response to the configuration request sent at block 220. When the determination at block 225 is negative, as is likely to be the case following installation of the application package 300, the computing device 112 proceeds to block 230. At block 230, the computing device 112 is configured to generate a registration request and transmit the registration request to the server 104. The registration request is addressed to the server 104, e.g., using the same server identifier as mentioned above in connection with block 220. The registration request can, for example, include a URL of the server 104 as well as an API call to a registration process implemented by the application 160. As will now be apparent, the APIs implemented by the application 160 can be public, e.g., accessible without authentication to permit new installations of the package 300 to register. APIs implemented by the enterprise application 108, on the other hand, may require authentication. That is, any requests to the application 108 by an un-registered device may simply be ignored.

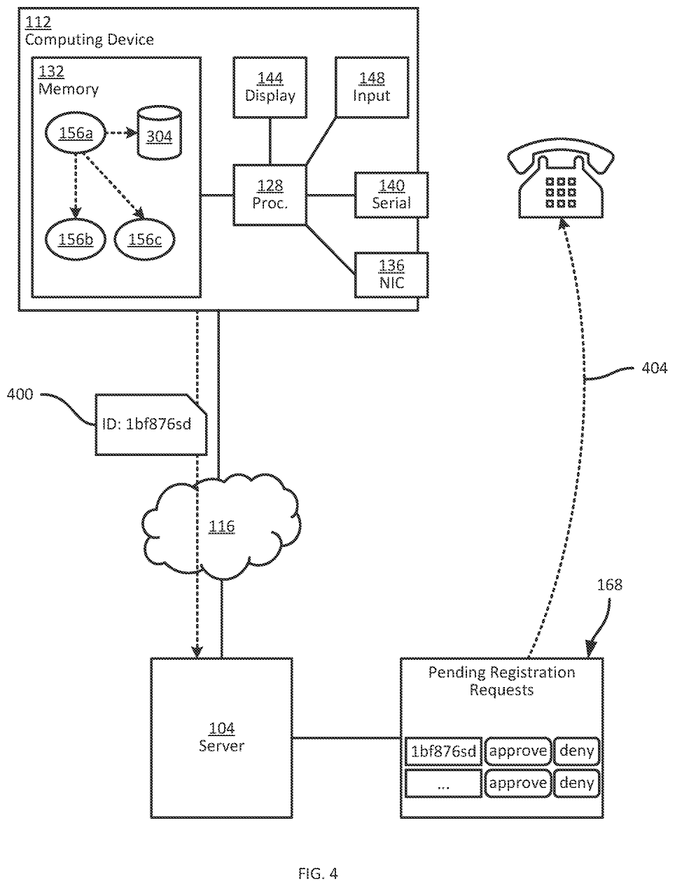

In response to sending the registration request at block 230, at block 235 the computing device 112 is configured to determine whether a registration process is complete. For example, the device 112 can be configured to periodically query the server 104, or to wait for a response to the registration request from the server 104. Turning to FIG. 4, an example registration request 400 is shown transmitted from the device 112 to the server 104, including the unique gateway identifier from block 215. In response to receipt of the registration request 400 at the server 104, a confirmation process can be initiated, e.g., by an operator of the server 104. For example, the confirmation process can include a side-channel confirmation of the registration request.

In some examples, any pending registration requests from the computing device 112 and other computing devices that have initiated performances of the method 200 can be viewed via the terminal 168. For example, the terminal 168 can list the unique gateway identifiers from such registration requests, along with selectable elements for approving or denying the registration requests. Because the distribution of the package 300 may be unconstrained (e.g., the package 300 may be publicly available), an operator of the terminal 168 may perform a side-channel confirmation by telephoning or otherwise contacting an operator of the computing device 112 (e.g., on premises 110). The side-channel confirmation can include, for example, a telephone call 404 or other communication with staff on premises, to request confirmation of the unique gateway identifier. For example, the control application 156c can render, on the display 144, the unique gateway identifier to permit on-premises staff to confirm the unique gateway identifier to the operator of the terminal 168.

The registration request can also include, in some examples, contact information enabling the side-channel confirmation. For example, the setup application 156a, during deployment of the firmware application 156b, can prompt an operator of the computing device 112 for contact information such as a telephone number, an email address, login credentials corresponding to an account maintained at the server 104, or the like, to permit the side-channel confirmation.

If the registration of the computing device 112 is denied, performance of the method 200 ends. For example, the server 104 can return a rejection message to the device 112. In the absence of a rejection message, when the determination at block 235 is negative, the device 112 can continue waiting for a response from the server 104.

When the determination at block 235 is affirmative, the device 112 can return to block 220, to generate and send a further configuration request. Substantially simultaneously with the side-channel registration confirmation discussed above, operator(s) of the server 104 can obtain information (e.g., via the telephone call 404, in some cases) identifying the peripheral devices 120, such as model numbers and the like. Such information can also include port identifiers corresponding to the interfaces 136 and 140, to which the peripheral devices 120 are connected. For example, the server 104 can obtain, via the side-channel confirmation process, an IP address and port number of the peripheral device 120-2 within the local area network implemented by the router 124, as well as a port identifier at the interface 140 to which the peripheral device 120-1 is connected.

Using the port identifiers, model numbers, and the like, operator(s) of the server 104 can generate configuration data for the firmware application 156b. The configuration data includes, for example, protocol attributes or other communications attributes permitting the computing device 112 to interact with the peripheral devices 120. The configuration data can include, in the case of the peripheral device 120-1, for example, a baud rate, a parity bit, signal timing, and the like. In the absence of such configuration data, the computing device 112 may be unable to exchange data with the peripheral device 120-1. The server 104 may, for example, store configuration data for a plurality of legacy devices, and in response to receiving information identifying the specific legacy devices 120 on the premises 110 via the side-channel confirmation noted above, the operator of the terminal 168 can select corresponding sets of configuration data from the repository 164. The selected set(s) of configuration data can be stored in the repository 164 in association with the unique gateway identifier corresponding to the computing device 112. The repository 164 can also, along with the generation of configuration data for the computing device 112, store a connection key in association with the unique gateway identifier. The connection key can be encrypted using, for example, an identifier of either or both of the interfaces 136 and 140 (e.g., a MAC address, a serial number, or the like).

When the registration request of the computing device 112 is approved, in other words, configuration data has also been prepared and stored in the repository 164. Therefore, the second performance of block 220 results in an affirmative determination at block 225. The computing device 112 therefore proceeds to block 240. At block 240, the computing device 112 stores the configuration data received at block 225 in the memory 132 in association with the firmware application 156b. The computing device 112 further establishes connections with the peripheral devices 120, using the configuration data.

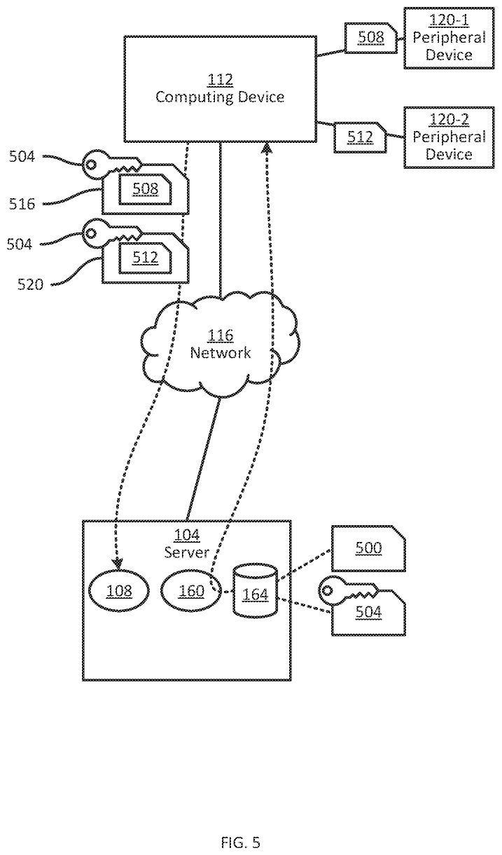

At block 245, the computing device 112, via the execution of the firmware application 156b, is configured to relay data between the peripheral devices 120 and the server 104. In particular, the data relayed by the firmware application 156b can include data from the peripheral devices 120, and commands to the peripheral devices 120. Turning to FIG. 5, an example performance of blocks 225, 240 and 245 is shown. In the illustrated example, following the side-channel confirmation of registration and the selection of configuration data for the computing device 112 at the server 104, configuration data 500 and a connection key 504, encrypted with hardware identifier(s) available to the computing device 112, are stored in the repository 164 in association with the unique gateway identifier. The configuration data 500 and the key 504 are transmitted to the computing device 112 at block 225, and at block 240 the computing device 112 establishes connections with the peripheral devices 120 (via the relevant interfaces 136 or 140).

The computing device 112 can then act as a relay between the peripheral devices 120 and the server 104, for example by receiving data 508 and 512 from the peripheral devices 120-1 and 120-2 respectively, and encapsulating the data for delivery to the server 104. The encapsulation can include generating messages 516 and 520, encrypted with the key 504, such as API calls to the application 108 identifying the relevant peripheral device 120.

During execution of the firmware application 156b, the control application 156c can render an indication on the display 144 that an encrypted connection is active with the server 104, for example. The control application 156c can also include a selectable command for restarting the firmware application 156b, e.g., to permit on-premises staff to conduct basic troubleshooting of the firmware application 156b.

Those skilled in the art will appreciate that in some embodiments, the functionality implemented by the processor 128 via execution of the applications 156 may be implemented using pre-programmed hardware or firmware elements (e.g., application specific integrated circuits (ASICs), electrically erasable programmable read-only memories (EEPROMs), etc.), or other related components.

The scope of the claims should not be limited by the embodiments set forth in the above examples, but should be given the broadest interpretation consistent with the description as a whole.

1. A method, comprising:
obtaining, at a processor of a computing device, a virtual gateway application package including a setup component and a firmware component containing a server identifier;
storing the virtual gateway application package in a memory of the computing device;
via execution of the setup component:
deploying the firmware component to the memory;
generating a unique gateway identifier; and
storing the unique gateway identifier in the memory;
via execution of the firmware component:
retrieving the unique gateway identifier and the server identifier;
generating a configuration request, addressed to the server identifier and including the unique gateway identifier;
receiving configuration data defining connection parameters for at least one peripheral device connected to the computing device; and
establishing a connection with the at least one peripheral device according to the connection parameters.

2. The method of claim 1, wherein the virtual gateway application package further includes a monitoring component; the method further comprising:
via execution of the setup component, deploying the monitoring component to the memory; and
via execution of the monitoring component, displaying a status indicator corresponding to the firmware component.

3. The method of claim 1, further comprising, via execution of the firmware component:
prior to receiving the configuration data, receiving an indication that no configuration data is available;
generating a registration request addressed to the server identifier and containing the unique gateway identifier; and
transmitting the registration request.

4. The method of claim 3, further comprising:
following a side-channel confirmation of the registration request at the server, receiving a registration notification;
transmitting a second configuration request; and
receiving the configuration data in response to the second configuration request.

5. The method of claim 4, wherein the configuration data includes a connection key; and
wherein the method further comprises establishing a secure connection, using the connection key, with an enterprise application associated with the server identifier.

6. The method of claim 5, wherein the connection key is encrypted using an identifier of a communications interface of the computing device; and wherein the method further comprises decrypting the connection key prior to establishing the secure connection.

7. The method of claim 1, further comprising:
in response to establishing the connection with the at least one peripheral device, relaying data between the at least one peripheral device and the server.

8. A computing device, comprising:
a memory;
a communications interface; and
a processor configured to:
obtain a virtual gateway application package including a setup component and a firmware component containing a server identifier;
via execution of the setup component:
deploy the firmware component to the memory;
generate a unique gateway identifier; and
store the unique gateway identifier in the memory;
via execution of the firmware component:
retrieve the unique gateway identifier and the server identifier;
generate a configuration request, addressed to the server identifier and including the unique gateway identifier;
receive configuration data defining connection parameters for at least one peripheral device connected to the computing device; and
establish a connection with the at least one peripheral device according to the connection parameters.

9. The computing device of claim 8, wherein the virtual gateway application package further includes a monitoring component; and wherein the processor is further configured to:
via execution of the setup component, deploy the monitoring component to the memory; and
via execution of the monitoring component, display a status indicator corresponding to the firmware component.

10. The computing device of claim 8, wherein the processor is further configured, via execution of the firmware component, to:
prior to receiving the configuration data, receive an indication that no configuration data is available;
generate a registration request addressed to the server identifier and containing the unique gateway identifier; and
transmit the registration request.

11. The computing device of claim 10, wherein the processor is further configured to:
following a side-channel confirmation of the registration request at the server, receive a registration notification;
transmit a second configuration request; and
receive the configuration data in response to the second configuration request.

12. The computing device of claim 11, wherein the configuration data includes a connection key; and
wherein the processor is further configured to establish a secure connection, using the connection key, with an enterprise application associated with the server identifier.

13. The computing device of claim 12, wherein the connection key is encrypted using an identifier of a communications interface of the computing device; and wherein the processor is further configured to decrypt the connection key prior to establishing the secure connection.

14. The computing device of claim 8, wherein the processor is further configured to:
in response to establishing the connection with the at least one peripheral device, relay data between the at least one peripheral device and the server.

15. A non-transitory computer-readable medium storing a plurality of computer-readable instructions executable by a processor of a computing device to:
obtain a virtual gateway application package including a setup component and a firmware component containing a server identifier;
via execution of the setup component:
deploy the firmware component to a memory;
generate a unique gateway identifier; and
store the unique gateway identifier in the memory;
via execution of the firmware component:
retrieve the unique gateway identifier and the server identifier;
generate a configuration request, addressed to the server identifier and including the unique gateway identifier;
receive configuration data defining connection parameters for at least one peripheral device connected to the computing device; and
establish a connection with the at least one peripheral device according to the connection parameters.
